(19) United States
(12) Patent Application Publication
(10) Pub. No.: US 2025/0217570 A1
(43) Pub. Date: Jul. 3, 2025

(54) RULE PLATFORM FOR SEMICONDUCTOR MANUFACTURING

(71) Applicant: Intel Corporation, Santa Clara, CA (US)

(72) Inventors: Chih-Yuan Yang, Portland, OR (US); Yuejun Fu, Portland, OR (US); Matthew K. Gumbel, Portland, OR (US); Cher-Yin Khor, Pulau Pinang (MY); Ashish V. Sangwai, Austin, TX (US)

(73) Assignee: Intel Corporation, Santa Clara, CA (US)

(21) Appl. No.: 18/399,149

(22) Filed: Dec. 28, 2023

(51) Int. Cl. G06F 30/398; G06F 30/392; G06F 119/18; G06F 119/20

(52) U.S. Cl. CPC G06F 30/398; G06F 30/392; G06F 2119/18; G06F 2119/20

(57) ABSTRACT

A method comprising receiving, at a computing system, a request for design rules of an integrated circuit technology node; and providing, by the computing system, a plurality of design rule entries for display in a tabular format by an interface, the plurality of design rule entries selected based on the request, a design rule entry of the plurality of design rule entries corresponding to a design rule of the plurality of design rules, the design rule entry comprising a first cell designated for a label of the design rule, a second cell designated for a description of the design rule, and a third cell designated for a numerical dimension for the design rule.

### TECHNICAL FIELD

This disclosure relates in general to the field of computing systems and, more particularly, to a design rule platform for semiconductor manufacturing.

### BACKGROUND

Cutting-edge semiconductor manufacturing processes are terribly complex. Housed in billion-dollar factories and comprising hundreds of processing steps to yield a finished device, they are capable of reliably printing features as small as 3 nm hundreds of billions of times across wafers that extend a foot in diameter. Developing a new semiconductor manufacturing process requires defining a set of complex design rules that establish constraints that a semiconductor device must follow to ensure manufacturability.

### BRIEF DESCRIPTION OF THE DRAWINGS

FIG. 1 illustrates an interface displaying a table of design rules in accordance with certain embodiments.

FIG. 2 illustrates an interface displaying a comprehensive view of a selected design rule in accordance with certain embodiments.

FIG. 3 illustrates an interface displaying a comparison of design rules for different technology nodes in accordance with certain embodiments.

FIG. 4 illustrates an interface displaying a comparison of design rules for different versions of design rules for a particular technology node in accordance with certain embodiments.

FIG. 5 illustrates an interface displaying analytics for a design rule platform in accordance with certain embodiments.

FIG. 6 illustrates an architecture for providing a design rule platform in accordance with certain embodiments.

FIG. 7 illustrates data abstraction and a hierarchy that may be used by the platform in accordance with certain embodiments.

FIG. 8 illustrates a flow for providing a design rule platform in accordance with certain embodiments.

FIG. 9 illustrates a computing system in accordance with certain embodiments.

Like reference numbers and designations in the various drawings indicate like elements.

### DESCRIPTION OF EXAMPLE EMBODIMENTS

Semiconductor manufacturing has become increasingly complex over the years. Since the turn of the century, the minimum feature size has shrunk by over an order of magnitude as the industry has progressed from the 130 nanometer (nm) to 3 nm technology nodes. In semiconductor manufacturing, a technology node (also referred to as a process node) may refer to a specific semiconductor manufacturing process. A technology node historically referred to a semiconductor feature size (e.g., channel length) measured in nanometers (nm), though recently some technology node names have become decoupled from specific feature sizes and instead generally refer to relative size, performance, and/or power consumption of integrated circuits built using the technology node.

Over the years, processor complexity has dramatically increased. Current flagship products have transistor counts that well exceed 10 billion. To handle these reduced feature sizes and increased chip complexities, companies must invest billions of dollars and years of research to build state-of-the-art fabrication facilities. Research and development costs are driven ever-upward by the rising cost of increasingly sophisticated equipment needed for advanced processes. The industry has taken steps to decrease per-transistor manufacturing costs (for example, by moving to larger wafers), but the overall trend has been for each process generation to cost more than the last. With up to hundreds of individual dies on wafers that span a foot in diameter, the total number of transistors that can be printed on a wafer is on the order of one trillion. Developing high-volume manufacturing processes that can reliably manufacture transistors at such an extreme scale presents considerable challenges.

Essential to semiconductor manufacturing is the process of photolithography, by which patterns are transferred from a mask onto a wafer. Masks are used to define the shape and location of various features to be patterned on a wafer for a given process layer. For example, one mask defines where oxide regions are located, another mask defines where high-k dielectrics will be located, another mask defines locations of source and drain regions, and yet another mask defines where contacts will be placed. Additional masks may be used to define each metal layer and intervening via layers.

As masks are the means by which features are realized in semiconductor devices, any semiconductor device design must ultimately be reduced to a physical design, the level of design abstraction from which masks are to be generated. The physical design of a transistor, circuit, or processor to be manufactured is often referred to as a “layout.” Electronic design automation (EDA) tools allow processor architects and circuit designers to design at levels of abstraction above the physical design level. Architects typically define their designs using a hardware design language (HDL), such as VHDL or Verilog. Once they have verified that their designs perform as desired, a physical design can be generated automatically using a library of standard layout cells. Circuit designers often seek performance or functionality not available using standard cells and often enter their designs into a schematic capture tool. Once their custom designs are finalized, the circuit schematics are handed off to layout designers who manually craft the custom physical designs.

Regardless of whether a physical design is generated automatically or manually it must conform to a set of layout design rules established for a manufacturing process. Design rules are constraints that a physical design must follow to ensure manufacturability. Most design rules express a minimum width or space for a feature of an integrated circuit, such as, “gate length≥10 nm,” “source/drain diffusion enclosure of a contact≥16 nm,” and “space between metal-1 traces≥20 nm.” Design rules represent a trade-off between feature density and manufacturability. Being able to print smaller feature sizes can mean more die can be packed onto a wafer but if the process cannot reliably print the smaller features, the resulting reduction in wafer yield can more than offset cost reduction gained by being able to print more die on a wafer.

Thus, design rules are a key component to develop and ramp a new semiconductor manufacturing process. During process development, the design rules undergo many changes which rule developers and consumers must review, inspect, and edit. Typically, design rules are disseminated to fab and design engineers via a flat, static PDF file or the like (which may span hundreds or thousands of pages). Searching for critical information in such a format is slow, inefficient, and error prone. When dealing with different versions of design rule data (e.g., when updating a design to a new technology node), users may spend significant time cross referencing multiple documents.

Various embodiments of the present disclosure provide a dynamic platform for design rules. The interfaces provided by the dynamic platform are designed to be intuitive for design rule lookup, comparison, and collaboration. In this platform, data may be consumed by multiple mechanisms while data integrity and versioning are maintained. In various embodiments, the platform may provide novel views of design rule data, link users quickly to relevant related data, and enable comparisons between multiple manufacturing technologies. In some embodiments, the platform may provide automated visualization for data comparison, difference highlighting, and change evolution.

In the platform, design rules may be modularized into abstraction and normalized in a database management system (DBMS). The data abstraction by relational model promotes better reusability and facilitates data mobility. Rules stored in the DBMS may allow enforcement of a single source of truth. Developers can view the same set of data, negotiate, and collaborate the design rules in real-time.

The platform may utilize modern web and/or application programming interfaces (APIs) to visualize, locate, and retrieve rules for both human users and applications (e.g., EDA tools). Integration with semiconductor Electronic Design Automation (EDA) tools can be achieved through Uniform Resource Locators (URLs) or REST APIs, promoting improved collaboration.

Data comparison across different versions or time evolution is enabled by automated queries. The platform may also track access and modification history, creating a thorough paper trail.

Various embodiments may provide technical advantages, such as reduced errors and improvement in time-consumed for closing on outstanding physical verification related issues before tapeout, development of process-design kits, foundational IP within foundries, or test chip design for process development and validation at pathfinding or the design technology co-optimization (DTCO) stage of advanced semiconductor process nodes.

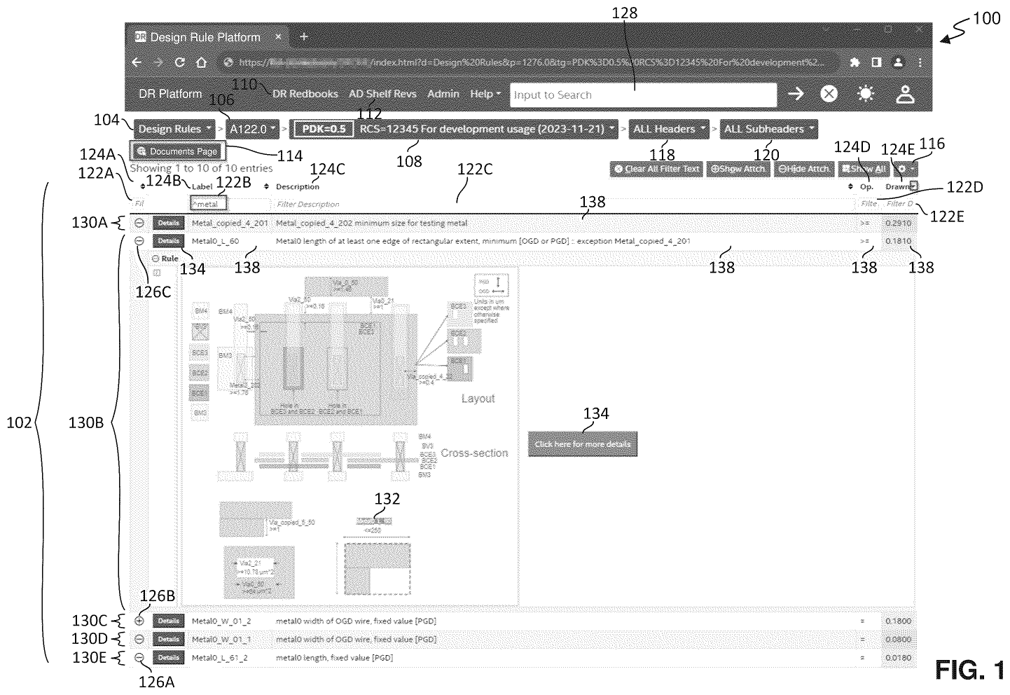

FIG. 1 illustrates an interface 100 displaying a table of design rules in accordance with certain embodiments. The interface 100 may be provided to various users by the platform and in some embodiments the platform is implemented as a web-based application which enables access to the design rules data through an interface such as a browser (as depicted in FIG. 1) or an API. In this interface, the design rules are displayed in a tabular format (e.g., table 102) for easy reviewing with filtering and sorting functionalities. The tabular view of the design rules provides the ability for intuitive data characterization and consistency. Rows in this tabular view may be expandable to enable the user to see related diagrams for a given design rule directly in-line. A row may be referred to as a design rule entry (e.g., 130), where a design rule entry is a representation of a particular design rule with various fields in cells (e.g., 138) of the row.

The interface includes a main menu 104 with selectable options. In various embodiments, the main menu options may include any of the following: Design Rules, Rule Details, Technology Information, Rule Change Log, and Compare Technologies.

The interface also includes a technology node selector 106 and a version selector 108. The technology node selector 106 allows a user to select a technology node that corresponds to a particular manufacturing process. In the embodiment depicted, the technology node is set to A122 (a fictitious process name provided by way of example). The version selector 108 allows a user to select a version of the design rules for the selected technology node. In the embodiment depicted, the version is set to process design kit (PDK) 0.5. In various embodiments, the platform may enforce security such that a given user is only able to access design rules and other information for the technology nodes and versions for which the user has permission.

The selected technology node and version act as filters for information (e.g., design rules, technology information associated with design rules, etc.) provided by the interface. Information provided by the interface may also be fileted based on a selected mode. For example, when the DR Redbooks mode is selected (e.g., by clicking on the link 110), the results displayed include design rules that are exposed to design teams for use in layout design. As another example, when the AD Shelf Revs mode is selected (e.g., by clicking on the link 112), only the design rules under development are displayed.

The Documents Page link 114 may open a page that allows the user to view a document (e.g., a PDF document) that is generated from the same source data that the platform uses to provide the design rules in the tabular format but that is organized differently (e.g., the document may present the design rules in a sequential manner as is traditionally done in design rule documents). As just one example, the source data may include design rule text stored in text files (such comma or tab separated value files) and a collection of images (e.g., in a .svg format or other suitable format in a repository, such as a Git repository).

Additional information about the design rules may also be viewed by selecting Technology Information in the main menu 104. Based on this selection, the interface may display free form text about the design rules (e.g., in a format similar to the file accessible via the Documents Page link), rather than the tabular format shown in FIG. 1. The Technology Information view may allow for viewing this information in the interface without opening up an additional file. Either the document available at the Documents Page link or the information available via the Technology Information view may include all of the applicable design rules as well as additional background information about use of the rules. For example, such information may include various pages about rule label conventions, description syntax explanations, design rule terminologies, information about various layers, or other suitable information. The information shown may be filtered by a selected technology node and version. The Technology Information contents may be generated from the same source data as the document at the Documents Page link.

Returning again to the view of FIG. 1, viewable fields within the table 102 of design rules may include one or more of a header, a subheader, a label, a description, a drawn value, and an operator. The columns that are shown in the table view may be selectable by the user (e.g., by manipulating the configuration selector 116). In some embodiments, selector 116 may also allow the user to configure whether column filters should be applied using a Boolean AND operation or a Boolean OR operation (when multiple words are entered in the search fields 122).

In various embodiments, design rules may be organized by headers and subheaders. A header may include a descriptive title of a group of design rules and a subheader may include a descriptive title for a subset of the group of design rules associated with the header. For example, a first header may apply to metal layer 0 (m0) rules, a second header may apply to metal layer 1 (m1) rules, a third header may apply to top die bump interposer rules, and so on. As another example, a first subheader for a header could apply to width rules, a second subheader could apply to length rules, a third subheader could apply to spacing rules, and so on. At least some of the design rules may be associated with a header and a subheader. The header and subheader grouping may function similarly to a table of contents, allowing identification of relevant design rules by browsing or searching focused on a subset of the design rules. For example, selection of a particular header and subheader combination via header menu 118 and subheader menu 120 may limit the design rules displayed in the table 102 to those associated with the selected header and subheader combination.

A label includes a short name for the design rule. A description provides a text description of the design rule (e.g., by explaining what the drawn value refers to). The drawn value is a number associated with the design rule that represents a dimension such as a width, length, spacing requirement, or other suitable dimension. Some design rules do not have drawn values (and thus the value of the drawn value for such rules may be null and may be displayed as blank, with “N/A”, or other suitable value indicating that no drawn value exists for the rule).

An operator is associated with the drawn value and further defines the acceptable range of drawn values for the design rule. In some embodiments, one or more of =, >, and < operators may be specified in the operator field in association with the drawn value. For example, for an operator specifying >, the value used in the design must be greater than the drawn value; for an operator specifying <=, the value used in the design must be less than or equal to the drawn value, and so on.

The results that are shown in the table 102 may be filtered by any one or more of the fields. For example, filtering may be initiated by entering a search value in a search field 122. In some instances, a search field may be displayed underneath a respective column header that indicates the type of value included in the cells of that column. For example, label search field 122B is located below header 124B denoting “Label”, description search field 122C is located below header 124C denoting “Description”, operator search field 122D is located below header 124D denoting “Op.”, and drawn value search field 122E is located below header 124E denoting “Drawn”. Search field 122A is also present underneath header 124A which does not include text as the cells in the column underneath header 124A simply include expanders 126 as explained below.

In various embodiments, any suitable type of search may be performed through text entered into a search field 122. In one example, the search fields may support regular expression searching. In another example, the search fields may support Boolean searches. In yet another example, the search fields may support simple keyword matching searches. In some embodiments, the search bar may dynamically suggest search terms based on text entered into the search bar (e.g., the search box may implement real-time autocompletion).

In the embodiment depicted, the regular expression “\hat{ }metal” has been entered in the label search field 122B and thus the results in table 102 includes design rule entries with labels starting with “metal”. The other search fields may offer similar abilities to search along the respective field. For example, search field 122A may allow searches for non-expandable or expandable design rule entries (e.g., as will be explained later), the description search field 122C may allow for searches within the description fields of the design rule entries, operator search field 122D may allow for searches within the operator fields of the design rule entries (e.g., only show rules with an operator of =), and drawn value search field 122E may allow for searches within the drawn value fields of the design rule entries.

In some embodiments, the interface 100 may utilize semantic hypertext markup language (HTML) to provide a tabular view of the comparison that may perform the filtering and/or sorting locally (e.g., by the computing device executing a browser providing the interface 100). For example, an initial request for design rules of a technology node may result in the platform returning all of the design rules for that technology node to a front end interface (e.g., a web browser). The interface may then filter these rules based on user input received at the interface.

A freeform search bar 128 may also be used to search for a specific design rule or associated information. Searches performed via the search bar 128 may search the design rules, associated figures, and Technology Information pages for the selected technology node and PDK version (in other embodiments, the search could be performed across multiple technology nodes and/or PDK versions). Selection of a search result may result in display of the corresponding design rule (e.g., the comprehensive format described below), figure, or portion of the Technology Information pages.

The design rule entries 130 shown in table 102 may be sorted according to any of the headers 124, e.g., by clicking the double arrows within the desired header. For example, the design rule entries (e.g., rows) of the table may be sorted alphabetically based on the label or description field (e.g., via header 124B or 124C), numerically based on the drawn value field (e.g., via header 124E), by operator type based on the operator field (e.g., via header 124D), or by expandability (e.g., via header 124A).

In the embodiment depicted, the design rule entries provided in the table 102 may be presented in a simple format or an expanded format. In the embodiment depicted, design rule entries 130A, 130C, 130D, and 130E are shown in a simple format, while design rule entry 130B is shown in an expanded format.

In the simple format, any figures that are associated with the design rule are not displayed. Thus, the simple format includes text values in the cells (e.g., the unit at the intersection of a column and a row) under the headers that are configured to be viewable. In the embodiment depicted, these cells, for a particular design rule shown in simple format, include a label, a description, one or more operators, and a drawn value. In the simple format, the expander 126 indicates whether the underlying design rule is associated with figures. For example, expander 126A indicates that the design rule represented by design rule entry 130E does not have any associated figures and thus the design rule entry is not expandable. In contrast, expander 126B indicates that the design rule represented by design rule entry 130C does have one or more associated figures, and thus the design rule entry is expandable. When a design rule entry (e.g., 130B) is already expanded, the corresponding expander 126C may be pressed to revert the design rule entry back to the simple format (and the value of the expander 126C may toggle back to the same value as expander 126B).

In the expanded format (as illustrated by design rule entry 130B), the same text information that was shown in the simple format may be displayed in addition to one or more figures associated with the underlying design rule. A figure may illustrate implementation of the design rule. In some embodiments (such as the one depicted), the figure may occupy an entire row underneath the row of the design rule entry with the cells comprising text information. In the depicted embodiment, the figure includes a highlight 132 around the label in the figure (e.g., depicting a dimension for the design rule). In instances where a design rule is associated with multiple figures, the expanded format may display one of the figures at a time or multiple figures concurrently. In some embodiments, when a design rule is associated with multiple figures, the expanded format may display one of the figures and selectable indicia of (e.g., links to) one or more figures that are not displayed, so that the user may select one of the indicia to actively display the figure indicated by the indicium within the expanded format.

In various embodiments, a figure may illustrate the implementation of multiple design rules and thus may be associated with each of the illustrated design rules (such that an expanded view for any particular one of these design rules will include the figure, optionally with the label of the particular design rule highlighted). This feature is a vast improvement over a single design rule document (e.g., a PDF), where a figure illustrating multiple design rules may be located far away from a description of one or more of the design rules illustrated in the figure.

A design rule entry (whether displayed in simple format or expanded format) may also have one or more selectable links 134 (e.g., in the same row as the cells comprising the textual information) or 136 (e.g., next to the figure) to a comprehensive format for the design rule. When such a link is selected, the view may change from the list oriented view to a view that is centric to the selected design rule. The main menu 104 may also change from Design Rules to Rule Details. The comprehensive format may include any subset (or all) of the information that is included in the simple format or expanded format, as well as additional information.

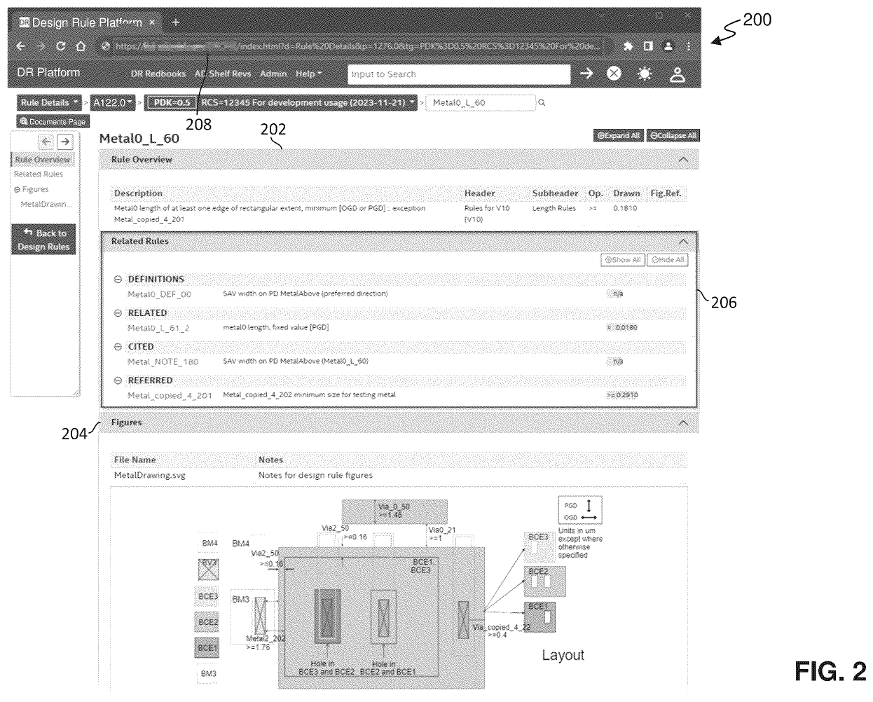

FIG. 2 illustrates an interface 200 displaying a comprehensive view of a selected design rule in accordance with certain embodiments. In this instance, the design rule labeled Metal0_L_60 is shown. The comprehensive view may include a rule overview section 202 with various fields (e.g., at least some of which may also be shown in the cells of the simple format version of the corresponding design rule entry), such as description, header, subheader, operator, drawn value, and figure reference. The comprehensive view also includes a figures section 204 which may display the figures associated with the design rule in a manner similar to that shown in the comprehensive format of FIG. 1 (in FIG. 2, the figures section is truncated at the bottom, but in operation the truncated portion may be displayed, e.g., by scrolling down in the interface if the entire figures section 204 doesn't fit on the display).

The comprehensive view also includes a related rules section 206 that displays indications of design rules that are associated with the selected design rule (and any suitable information about the related rules, such as the respective descriptions, drawn values, and operators as shown). The platform may utilize various designations for different types of relations between rules. For example, in the embodiment depicted, the relationships include definitions, related, cited, and referred. Any of these relationship types may be contracted (to hide the rules related to the selected design rule according to the relationship type) or expanded (to show the related rules). In the embodiment depicted, each relationship type is expanded and each relationship type includes one rule of the respective relationship type.

Any suitable relationship types may be used. For example, a “definitions” relationship may be used. Some design rules may recite relationships between two different layers. A definition design rule may recite a definition of a layer. Having the definition design rule in the same view as the design rule referring to the layer defined by the definition design rule may greatly facilitate understanding of the referring design rule. Thus, in the embodiment depicted, the description of the Metal0_L_60 design rule references Metal0 and the Metal0_DEF_00 rule is included as a related definition design rule.

As another example, a “related” relationship may exist when design rules have a family relationship (e.g., parent, child, sibling). For example, when a particular design rule (referred to as a parent) is to be associated with multiple drawn values (e.g., because a single drawn value, even in conjunction with the operators, isn't sufficient to specify the values allowed for the parameter of the design rule), a plurality of design rules which are siblings to each other may be designated as children of the parent design rule and may each specify a drawn value. In the depicted embodiment, the Metal0_L_61_2 design rule is a child of the Metal0_L_60 design rule.

As another example, a “cited” relationship type may indicate that the selected design rule was cited in the description of the related design rule (as evident by the depicted inclusion of Metal0_L_60 in the description of Metal_NOTE_180).

As yet another example, a “referred” relationship type may indicate that the related design rule was cited in the description of the selected design rule (as evident by the depicted inclusion of Metal_copied_4_201 in the description of Metal0_L_60).

Although not shown, in some embodiments, the comprehensive view may also include information about the version history of the design rule, such as when the design rule was created or modified or a link to the Rule Change Log view (to be described below) for the design rule.

Although not shown, in some embodiments, the comprehensive view may also include links to one or more Technology Information pages in which the selected design rule was referenced.

In various embodiments, the platform may utilize deep links (e.g., 208) for specific pages (e.g., the comprehensive view for a particular design rule may be accessed by any number of users via a common deep link specific to that design rule). The deep links may be utilized by EDA applications for design rule data retrieval and referencing. For example, an application (e.g., a design rule checks (DRC) runset tool) may identify design rule violations in a design and include the violations in a report. In various embodiments, the EDA application may provide deep links to design rules of the platform that are violated by a design. The deep links may link, e.g., to the comprehensive view of a design rule. Such embodiments may provide improved (e.g., quicker and more efficient) analysis of violated design rules relative to an application that merely provides a list of violated design rules and/or references to design rules in a pdf document.

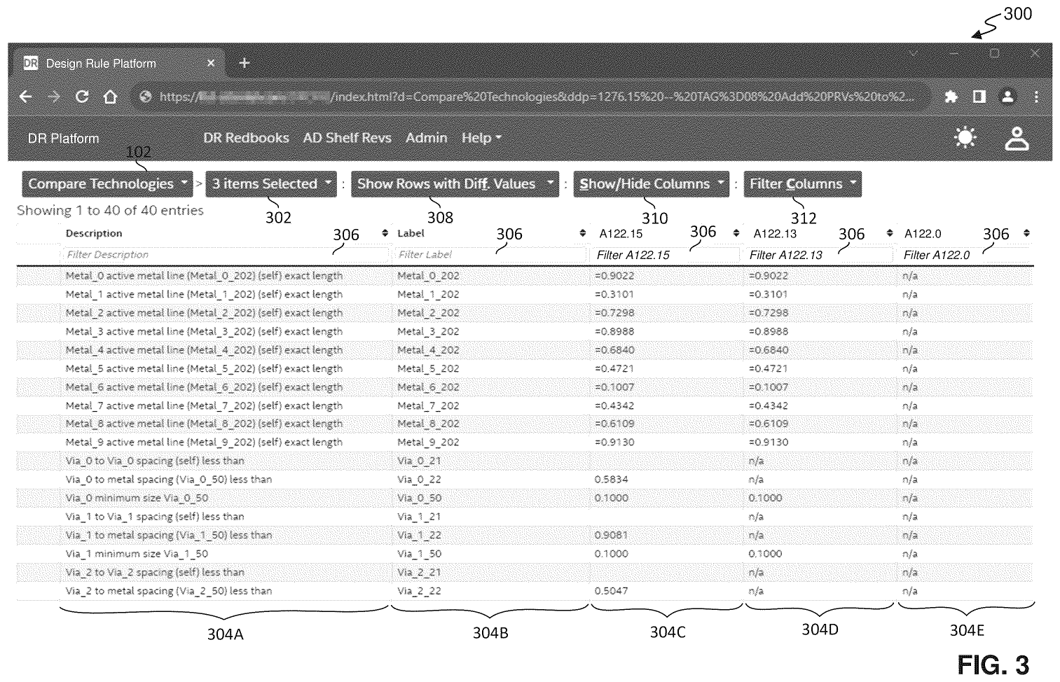

FIG. 3 illustrates an interface 300 displaying a comparison of design rules for different technology nodes in accordance with certain embodiments. The platform provides the ability to automatically compare design rules from multiple technology nodes at the same time, promoting efficiency and accuracy. In some embodiments, this interface 300 may utilize semantic HTML to provide a tabular view of the comparison that is filterable and/or sortable.

This view may be activated by selecting the Compare Technologies option in the main menu 104. The user may then select multiple technology nodes to compare from the drop down menu 302 (e.g., by checking boxes next to titles of the technology nodes or via other suitable selection means). Information about design rules from these selected technology nodes is then displayed in a tabular format.

In the embodiment depicted, technology nodes A122.15, A122.13, and A122.0 have been selected. Various columns may display information about the design rules that may be common across two or more of the selected technology nodes (unless that rule only exists for one of the technology nodes). For example, in the embodiment depicted, a first column 304A displays the descriptions of the design rules and a second column 304B displays the labels of the design rules.

A column that is specific to a particular selected technology node displays the drawn values and operators for the rules. For example, column 304C displays this information for the A122.15 technology node, column 304D displays this information for the A122.13 technology node, and column 304E displays this information for the A122.0 technology node. A particular cell in a row and column displays the drawn value and operator(s) for the particular rule of the row for the particular technology node of the column. If the rule doesn't exist for a technology node, the associated cell may be considered to have a null value and may be displayed as blank or populated with another value indicating such (e.g., “N/A”).

In the Compare Technologies view, the design rules shown may be filterable in any suitable manner, such as those described above with respect to FIG. 1. For example, the design rules may be filtered by description, label, operator, or drawn value (e.g., by entering search term(s) within the filter fields 306.

The view may also be customized using menus 308, 310, and 312. Menu 308 allows the user to select whether design rules that all have the same values are to be shown in the results. Such a feature may be useful when a designer is porting a design to another technology node and desires to be informed as to which design rules have different drawn values. Menu 310 may allow configuration of the “Description” and/or “Label” columns are shown or hidden. Menu 312 enables a search across multiple columns simultaneously with a selected Boolean operation (e.g., AND, OR). For example, if the user selects both Description and Label in this menu and the Boolean operation AND, then the results will only include rows where both of the cell values for the Description and Label columns match their filter criteria.

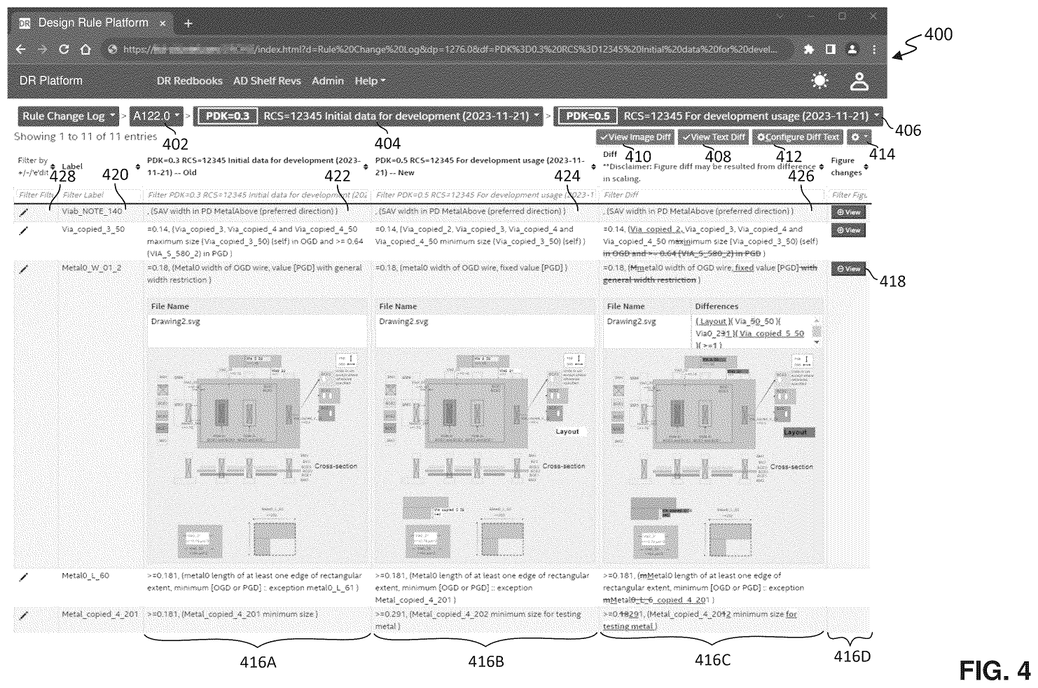

FIG. 4 illustrates an interface 400 displaying a comparison of design rules for different versions of design rule sets for a particular technology node in accordance with certain embodiments. In this interface, differences between rule versions within a selected technology node are automatically computed and highlighted in both text and visual data representations.

This view may be activated by selecting the Rule Change Log option in the main menu 104. This view depicts different versions (e.g., from different PDKs) of design rules from the same technology node.

When a technology node and two versions of design rule collections for that technology node are selected via selectors 402, 404, and 406, the platform may dynamically determine differences in the design rules between the versions and may render the text with formatting to show the changes. For example, text added to a version may be underlined and/or highlighted in a first color while text deleted from a version by be struck through and/or highlighted in a different color. Similar formatting may also be applied to figures associated with the design rules. This may facilitate quick updating of old designs to comply with new rules.

In various embodiments, the view may be configured by enabling or disabling display of the design rule text via selector 408, enabling or disabling display of the design rule figures via selector 410, changing the font, font size, and font colors of the cells in the column showing the differences via selector 412, choosing which data columns should be displayed via selector 414 (e.g., the user may desire to only see the rules or each version or the user may desire to only see the differences).

In the embodiment depicted, each selected version is shown in its own column 416A and 416B and then a separate column 416C displays the rule changes from the first selected version to the second selected version. Another column 416D may include expansion selectors 418 that when selected result in display of the figures in addition to the text.

A respective row may include a first cell 420 that identifies a design rule (e.g., via its label), a second cell 422 with text including the description and/or drawn values and operators for the design rule for the first selected version, a third cell 424 with text including the description and/or drawn values and operators for the design rule for the second selected version, and a fourth cell 426 identifying the changes between the second cell and the third cell. In the embodiment depicted, a fifth cell 428 may include an indication of whether a rule was added, removed, or edited between the first selected version to the second selected version.

In the embodiment depicted, when an expansion selector 418 for a particular design rule is selected, the second cell may include one or more figures associated with the design rule for the first version, the third cell may include one or more figures associated with the design rule for the second version, and the third cell may include changes between the figure(s) of the second cell and the figure(s) of the third cell.

In some embodiments, the information shown in the cells may be configurable via a menu accessible to the user in the Rule Change Log view. For example, instead of a cell including the operator(s), drawn value, and description, the user may configure the cell to show only the operator(s) and drawn value (or any other suitable combination of design rule information described herein). In other embodiments, the information shown in the cells may not be configurable.

As in the list view of FIG. 1, the rows of design rules may be sortable according to any of the fields depicted in the cell headers or filterable based on searches in the filter fields below the headers.

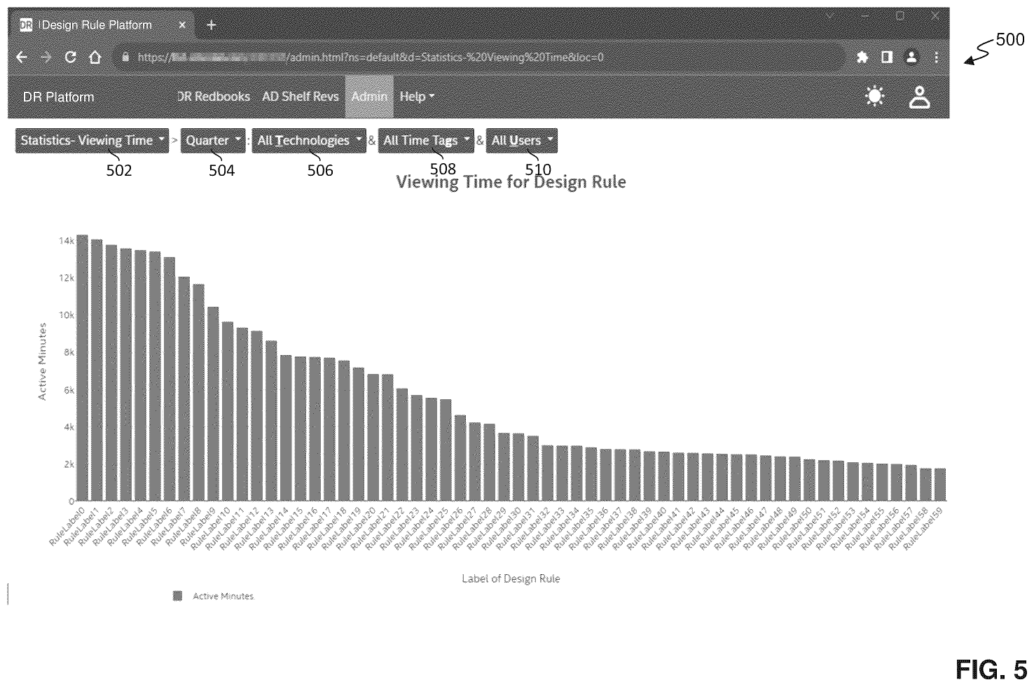

FIG. 5 illustrates an interface 500 displaying analytics for a design rule platform in accordance with certain embodiments. Any suitable analytics may be provided by the platform. In the embodiment depicted, the viewing time for the most viewed rules is displayed. The y-axis indicates an aggregate number of minutes viewed across the users of the platform while the x-axis includes rule labels. Such analytics may aid the design rule improvement process (e.g., simplification of the rules that are viewed the most often may result in increased efficiency).

In various embodiments, any other suitable metric may be viewed via the drop down menu 502 (e.g., the number of times rules were viewed, metrics on searches performed, etc.).

The metrics displayed may be filtered along any suitable parameter, such as the time period (e.g., through menu 504), the technology node(s) (e.g., through menu 506), particular subsets of the metric (e.g., through menu 508), or which user or group of users (e.g., through menu 510).

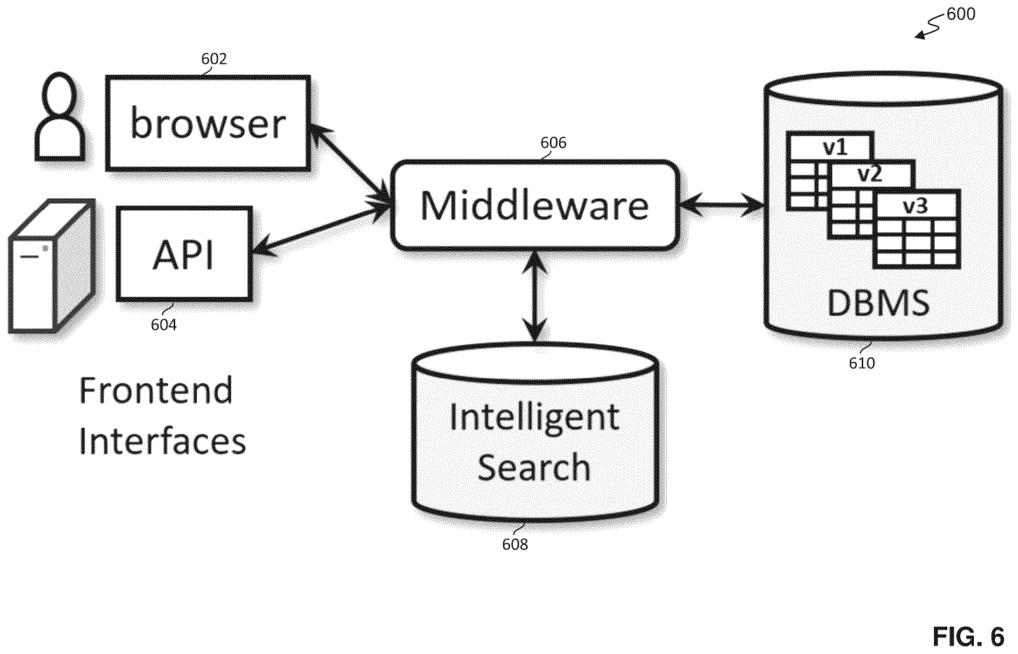

FIG. 6 illustrates an architecture 600 for providing a design rule platform in accordance with certain embodiments. Architecture 600 comprises frontend interfaces (e.g., browser 602 and API 604), middleware 606, search engine 608, and database 610. A frontend interface provides a shell for a user (e.g., via a browser) or a program such as an EDA tool (e.g., via an API) to access the platform services. For example, a web browser may display any of the interfaces depicted herein or variations thereof. Middleware 606 may function as a hub of the platform and enable real-time data retrieval, data uploading, security, governance, and auditing. The middleware may be implemented, e.g., by any suitable web application technology, such as Node.js®, etc. The middleware 606 may also provide data comparison and bridging searching capabilities. For example, queries may be passed to search engine 608 and then the middleware may present results back to the interfaces 602, 604. Search engine 608 may include any suitable logic or data to facilitate searching requested through a frontend interface 602, 604.

The database 610 may store a normalized form of the design rules. The database may host data abstraction, enforce design rule integrity, and allow concurrent access to the design rule data. The database may comprise, e.g., a relational database such as MySQL or the like. The data tables and their relationships within the database 610 may host the design rule and authorization information.

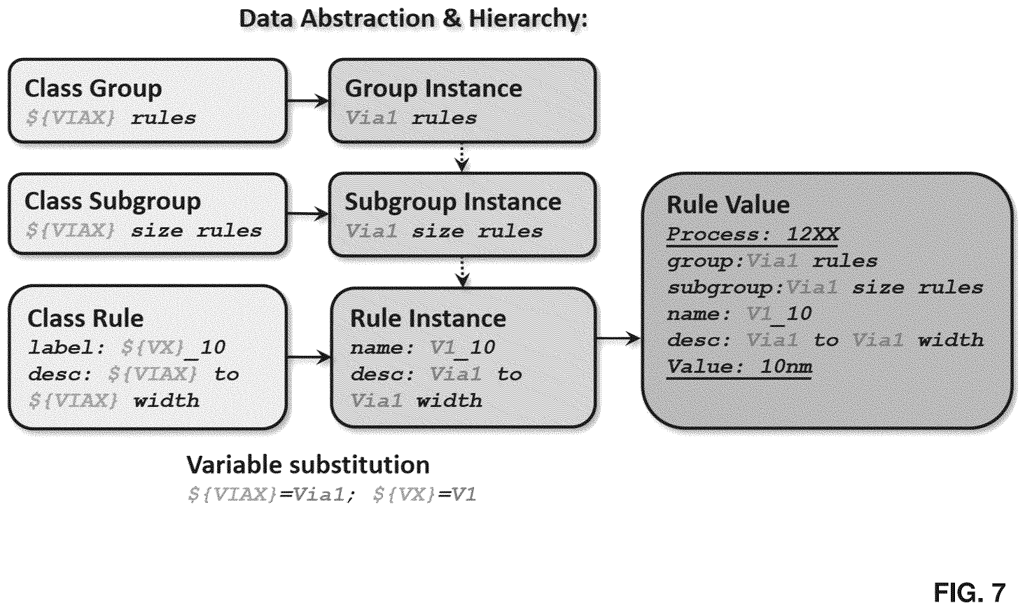

FIG. 7 illustrates data abstraction and a hierarchy that may be used by the platform in accordance with certain embodiments. Layout design rules are often similar between different layers or processes. To avoid data redundancy, design rules in the platform may be architected into classes, instance, and rule value entities. The class is the abstraction of the design rule. Each class defines a template for a rule which may have optional properties or diagrams. The template has rule information with tokens or variables which can be replaced during a class instantiation. The class can be grouped with related classes to form a group or a subgroup. A class can be realized into an instance after the meaningful values are filled into the variables. Each rule instance can be realized into a rule value for a specific process. The instance and class may be process-agnostic and can be shared between processes or rule sets. A process has a set of rule values which is specific for this fab process. The rule values could have inherited properties from instances, e.g., layout diagram, etc.

The design of data hierarchy and instantiation increases reusability and avoids repeated work when dealing with similar data between different layers. It also helps to enhance consistency for rule updates.

In the example shown in FIG. 7, the class is the base template for the rule. It has variables in the definition which can be substituted during instantiation. Both related classes and instances can be collected into groups or subgroups (e.g., shown in a vertical column). The bottom part of FIG. 7 shows class, instance and rule value entities. The rule value (e.g., the bottom right box) belongs to “Process 12XX” and has a value “10 nm” with a few attributes inherited from its linked instances.

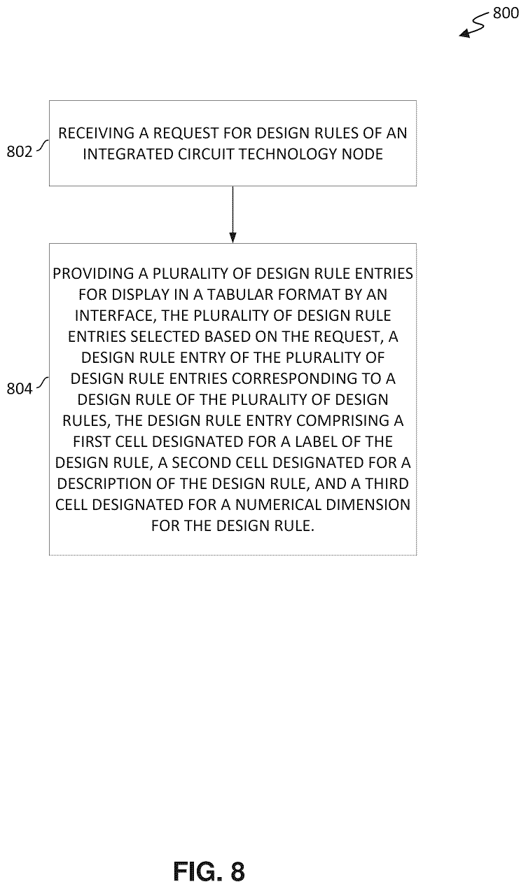

FIG. 8 illustrates a flow 800 for providing a design rule platform in accordance with certain embodiments. In a particular embodiment, any of the operations of flow 800 may be performed by any one or more components of architecture 600, computing system 900 (described in detail below), other suitable computing system, or other suitable logic.

At 802, a request for design rules of an integrated circuit technology node is received. The request may be generated, e.g., by a user through interacting with an interface, such as a web browser or other graphical user interface. The request may specify at least one filtering parameter, such as one or more integrated circuit technology nodes and/or one or more PDK versions, and/or other suitable filtering parameters. The request may be received at the interface and thus may be received by a computing system executing the interface. The request may also be received at one or more backend computing systems, e.g., over a network coupling the computing system executing the interface to the one or more backend computing systems.

At 804, a plurality of design rule entries are provided for display in a tabular format by an interface. The plurality of design rule entries may be selected based on the request. A design rule entry of the plurality of design rule entries corresponds to a design rule of the plurality of design rules. The design rule entry comprises a first cell designated for a label of the design rule, a second cell designated for a description of the design rule, and a third cell designated for a numerical dimension for the design rule.

In various embodiments, one or more backend or local computing systems may provide the design rule entries in any suitable coding format, such as any suitable markup language such as semantic HTML. The design rule entries may be provided to a computing system that executes a graphical user interface, such as a web browser. One or more components of the computing system (e.g., a network interface, a communication bus, etc.) may then provide the design rule entries to one or more other components of the computing system which render the design rule entries in the tabular format via an interface (e.g., a web browser).

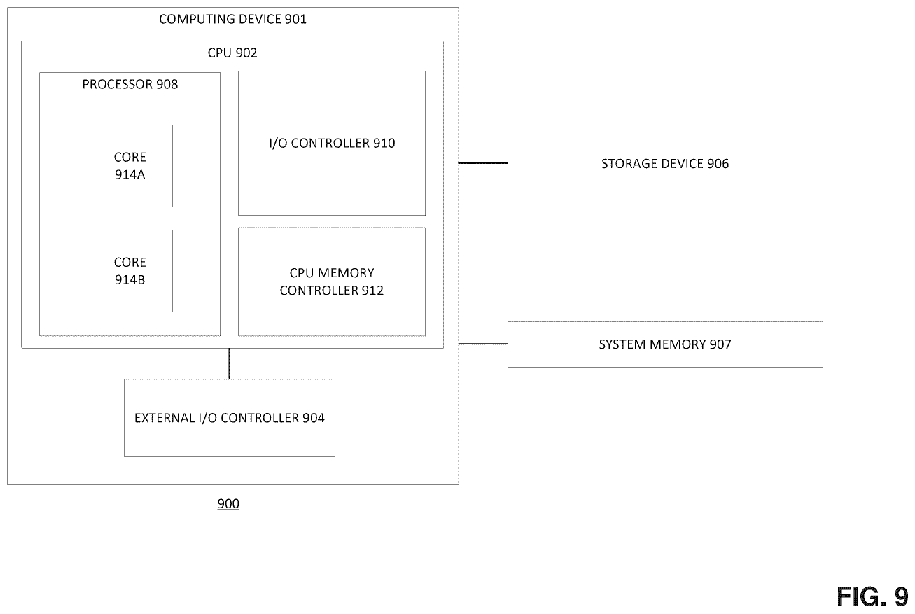

FIG. 9 illustrates a computing system 900 in accordance with certain embodiments. Any suitable components of system 900 may be used to perform any of the functions described above. For example, a system 900 may receive design rule data and provide it for display by a browser executed by system 900. As another example, a system 900 may be used to implement any of the components of architecture 600.

System 900 includes a computing device 901 comprising a central processing unit (CPU) 902 coupled to an external input/output (I/O) controller 904, storage device 906, and system memory 907. Although various components are illustrated, computing system 900 may include additional other components or multiples of the components illustrated.

During operation, data may be transferred between storage device 906 or system memory 907 and the CPU 902. In various embodiments, particular data operations (e.g., erase, program, and read operations) involving a storage device 906 or system memory 907 may be managed by an operating system or other software application executed by processor 908.

CPU 902 comprises a processor 908, such as a microprocessor, an embedded processor, a digital signal processor (DSP), a network processor, a handheld processor, an application processor, a co-processor, a system on a chip (SOC), or other device to execute code (i.e., software instructions). Processor 908, in the depicted embodiment, includes two processing elements (cores 914A and 914B in the depicted embodiment), which may include asymmetric processing elements or symmetric processing elements. However, a processor may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core 914 may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

In various embodiments, the processing elements may also include one or more arithmetic logic units (ALUs), floating point units (FPUs), caches, instruction pipelines, interrupt handling hardware, registers, or other hardware to facilitate the operations of the processing elements.

I/O controller 910 is an integrated I/O controller. I/O controller 910 may include logic for communicating data between CPU 902 and I/O devices, which may refer to any suitable devices capable of transferring data to and/or receiving data from an electronic system, such as CPU 902. For example, an I/O device may comprise an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input devices such as a monitor, printer, mouse, keyboard, or scanner; or other suitable device. In a particular embodiment, an I/O device may comprise a storage device 906 that may be coupled to the CPU 902 through I/O controller 910.

An I/O device may communicate with the I/O controller 910 of the CPU 902 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In particular embodiments, I/O controller 910 and the underlying I/O device may communicate data and commands in accordance with a logical device interface specification such as Non-Volatile Memory Express (NVMe) (e.g., as described by one or more of the specifications available at www.nvmexpress.org/specifications/) or Advanced Host Controller Interface (AHCI) (e.g., as described by one or more AHCI specifications such as Serial ATA AHCI: Specification, Rev. 1.3.1 available at http://www.intel.com/content/www/us/en/io/serial-ata/serial-ata-ahci-spec-rev1-3-1.html). In various embodiments, I/O devices coupled to the I/O controller may be located off-chip (i.e., not on the same chip as CPU 902) or may be integrated on the same chip as the CPU 902.

CPU memory controller 912 is an integrated memory controller. In various embodiments, CPU memory controller 912 may include any one or more characteristics of I/O controller 910. CPU memory controller may include logic to control the flow of data going to and from one or more system memories 907. CPU memory controller 912 may include logic operable to read from a system memory 907, write to a system memory 907, or to request other operations from a system memory 907. In various embodiments, CPU memory controller 912 may receive write requests from cores 914 and/or I/O controller 910 and may provide data specified in these requests to a system memory 907 for storage therein. CPU memory controller 912 may also read data from a system memory 907 and provide the read data to I/O controller 910 or a core 914. During operation, CPU memory controller 912 may issue commands including one or more addresses of the system memory 907 in order to read data from or write data to memory (or to perform other operations). In some embodiments, CPU memory controller 912 may be implemented on the same chip as CPU 902, whereas in other embodiments, CPU memory controller 912 may be implemented on a different chip than that of CPU 902. I/O controller 910 may perform similar operations with respect to one or more storage devices 906.

The CPU 902 may also be coupled to one or more other I/O devices through external I/O controller 904. In a particular embodiment, external I/O controller 904 may couple a storage device 906 to the CPU 902. External I/O controller 904 may include logic to manage the flow of data between one or more CPUs 902 and I/O devices. In particular embodiments, external I/O controller 904 is located on a motherboard along with the CPU 902. The external I/O controller 904 may exchange information with components of CPU 902 using point-to-point or other interfaces.

A system memory 907 may store any suitable data, such as data used by processor 908 to provide the functionality of computer system 900. For example, data associated with programs that are executed or files accessed by cores 914 may be stored in system memory 907. Thus, a system memory 907 may include a system memory that stores data and/or sequences of instructions that are executed or otherwise used by the cores 914. In various embodiments, a system memory 907 may store persistent data (e.g., a user's files or instruction sequences) that remains stored even after power to the system memory 907 is removed. A system memory 907 may be dedicated to a particular CPU 902 or shared with other devices (e.g., one or more other processors or other devices) of computer system 900.

In various embodiments, a system memory 907 may include a memory comprising any number of memory arrays, a memory device controller, and other supporting logic (not shown). A memory array may include non-volatile memory and/or volatile memory. Non-volatile memory is a storage medium that does not require power to maintain the state of data stored by the medium. Nonlimiting examples of nonvolatile memory may include any or a combination of: solid state memory (such as planar or 3D NAND flash memory or NOR flash memory), 3D crosspoint memory, memory devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), and magnetic storage memory. In some embodiments, 3D crosspoint memory may comprise a transistor-less stackable cross point architecture in which memory cells sit at the intersection of words lines and bit lines and are individually addressable and in which bit storage is based on a change in bulk resistance. Volatile memory is a storage medium that requires power to maintain the state of data stored by the medium. Examples of volatile memory may include various types of random access memory (RAM), such as dynamic random-access memory (DRAM) or static random-access memory (SRAM). One particular type of DRAM that may be used in a memory array is synchronous dynamic random-access memory (SDRAM). In some embodiments, any portion of memory 907 that is volatile memory can comply with JEDEC standards including but not limited to Double Data Rate (DDR) standards, e.g., DDR3, 4, and 5, or Low Power DDR4 (LPDDR4) as well as emerging standards.

A storage device 906 may store any suitable data, such as data used by processor 908 to provide functionality of computer system 900. For example, data associated with programs that are executed or files accessed by cores 914A and 914B may be stored in storage device 906. Thus, in some embodiments, a storage device 906 may store data and/or sequences of instructions that are executed or otherwise used by the cores 914A and 914B. In various embodiments, a storage device 906 may store persistent data (e.g., a user's files or software application code) that remains stored even after power to the storage device 906 is removed. A storage device 906 may be dedicated to CPU 902 or shared with other devices (e.g., another CPU or other device) of computer system 900.

In various embodiments, storage device 906 includes a storage device controller and one or more memory modules. In various embodiments, a memory module of storage device 906 comprises one or more NAND flash memory arrays, one or more hard disk drives, or other suitable memory storage devices. Storage device 906 may comprise any suitable type of memory and is not limited to a particular speed, technology, or form factor of memory in various embodiments. For example, a storage device 906 may be a disk drive (such as a solid-state drive), a flash drive, memory integrated with a computing device (e.g., memory integrated on a circuit board of the computing device), a memory module (e.g., a dual in-line memory module) that may be inserted in a memory socket, or other type of storage device. Moreover, computer system 900 may include multiple different types of storage devices. Storage device 906 may include any suitable interface to communicate with CPU memory controller 912 or I/O controller 910 using any suitable communication protocol such as a DDR-based protocol, PCI, PCIe, USB, SAS, SATA, FC, System Management Bus (SMBus), or other suitable protocol. A storage device 906 may also include a communication interface to communicate with CPU memory controller 912 or I/O controller 910 in accordance with any suitable logical device interface specification such as NVMe, AHCI, or other suitable specification. In particular embodiments, storage device 906 may comprise multiple communication interfaces that each communicate using a separate protocol with CPU memory controller 912 and/or I/O controller 910.

In some embodiments, all, or some of the elements of system 900 are resident on (or coupled to) the same circuit board (e.g., a motherboard). In various embodiments, any suitable partitioning between the elements may exist. For example, the elements depicted in CPU 902 may be located on a single die (i.e., on-chip) or package or any of the elements of CPU 902 may be located off-chip or off-package. Similarly, the elements depicted in storage device 906 may be located on a single chip or on multiple chips. In various embodiments, a storage device 906 and a computing device (e.g., CPU 902) may be located on the same circuit board or on the same device and in other embodiments the storage device 906 and the computing device may be located on different circuit boards or devices.

The components of system 900 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, and a Gunning transceiver logic (GTL) bus. In various embodiments, an integrated I/O subsystem includes point-to-point multiplexing logic between various components of system 900, such as cores 914, one or more CPU memory controllers 912, I/O controller 910, integrated I/O devices, direct memory access (DMA) logic (not shown), etc. In various embodiments, components of computer system 900 may be coupled together through one or more networks comprising any number of intervening network nodes, such as routers, switches, or other computing devices. For example, a computing device (e.g., CPU 902) and the storage device 906 may be communicably coupled through a network.

Although not depicted, system 900 may use a battery and/or power supply outlet connector and associated system to receive power, a display to output data provided by CPU 902, or a network interface allowing the CPU 902 to communicate over a network. In various embodiments, the battery, power supply outlet connector, display, and/or network interface may be communicatively coupled to CPU 902. Other sources of power can be used such as renewable energy (e.g., solar power or motion based power).

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

A module as used herein refers to circuitry and any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Logic may be used to implement any of the flows described or functionality of the various components such as CPU 902, external I/O controller 904, processor 908, cores 914A and 914B, I/O controller 910, CPU memory controller 912, storage device 906, system memory 907, subcomponents thereof, or other entity or component described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Example 1 includes at least one machine readable storage medium having instructions stored thereon, the instructions when executed by a machine to cause the machine to access at least one filter parameter specifying a plurality of design rules for at least one integrated circuit technology node; and provide a plurality of design rule entries for display in a tabular format by an interface, the plurality of design rule entries selected based on the at least one filter parameter, a design rule entry of the plurality of design rule entries corresponding to a design rule of the plurality of design rules, the design rule entry comprising a first cell designated for a label of the design rule, a second cell designated for a description of the design rule, and a third cell designated for a numerical dimension for the design rule.

Example 2 includes the subject matter of Example 1, and wherein the design rule entry comprises a fourth cell designated for at least one operator associated with the numerical dimension.

Example 3 includes the subject matter of any of Examples 1 and 2, and wherein the third cell and fourth cell comprise null values if the design rule does not specify a numerical dimension.

Example 4 includes the subject matter of any of Examples 1-3, and wherein the at least one filter parameter comprises an integrated circuitry technology node and a process design kit version.

Example 5 includes the subject matter of any of Examples 1-4, and wherein the design rule entry comprises a selector that when activated through user interaction with the interface initiates display of at least one figure illustrating application of the design rule.

Example 6 includes the subject matter of any of Examples 1-5, and wherein the display of the at least one figure illustrating application of the design rule includes a highlight of the label of the design rule.

Example 7 includes the subject matter of any of Examples 1-6, and wherein the design rule entry comprises a link that when selected through user interaction with the interface initiates display of the first cell, second cell, and third cell, a figure associated with the design rule, and a link to a page for a second design rule that is related to the design rule.

Example 8 includes the subject matter of any of Examples 1-7, and wherein a description of the second design rule cites the label of the design rule or the description of the design rule cites a label of the second design rule.

Example 9 includes the subject matter of any of Examples 1-8, and wherein the instructions when executed by the machine are to cause the machine to provide a group of cells in a tabular format, wherein a cell of the group of cells illustrates changes between a design rule for a first integrated circuit technology node and a corresponding design rule for a second integrated circuit technology node.

Example 10 includes the subject matter of any of Examples 1-9, and wherein the instructions when executed by the machine are to cause the machine to provide a group of cells in a tabular format, wherein a cell of the group of cells illustrates changes between a design rule for a first version of a design process kit for an integrated circuit technology node and a second version of a design process kit for the integrated circuit technology node.

Example 11 includes a method comprising receiving, at a computing system, a request for design rules of an integrated circuit technology node; and providing, by the computing system, a plurality of design rule entries for display in a tabular format by an interface, the plurality of design rule entries selected based on the request, a design rule entry of the plurality of design rule entries corresponding to a design rule of the plurality of design rules, the design rule entry comprising a first cell designated for a label of the design rule, a second cell designated for a description of the design rule, and a third cell designated for a numerical dimension for the design rule.

Example 12 includes the subject matter of Example 11, and wherein the design rule entry comprises a fourth cell designated for at least one operator associated with the numerical dimension.

Example 13 includes the subject matter of any of Examples 11 and 12, and wherein the third cell and fourth cell comprise null values if the design rule does not specify a numerical dimension.

Example 14 includes the subject matter of any of Examples 11-13, and wherein the design rule entry comprises a selector that when activated through user interaction with the interface initiates display of at least one figure illustrating application of the design rule.

Example 15 includes the subject matter of any of Examples 11-14, and wherein the display of the at least one figure illustrating application of the design rule includes a highlight of the label of the design rule.

Example 16 includes the subject matter of any of Examples 11-15, and wherein the design rule entry comprises a link that when selected through user interaction with the interface initiates display of the first cell, second cell, and third cell, a figure associated with the design rule, and a link to a page for a second design rule that is related to the design rule.

Example 17 includes the subject matter of any of Examples 11-16, and wherein a description of the second design rule cites the label of the design rule or the description of the design rule cites a label of the second design rule.

Example 18 includes the subject matter of any of Examples 11-17, and wherein the at least one filter parameter comprises an integrated circuitry technology node and a process design kit version.

Example 19 includes the subject matter of any of Examples 11-18, and further including providing a group of cells in a tabular format, wherein a cell of the group of cells illustrates changes between a design rule for a first integrated circuit technology node and a corresponding design rule for a second integrated circuit technology node.

Example 20 includes the subject matter of any of Examples 11-19, and further including providing a group of cells in a tabular format, wherein a cell of the group of cells illustrates changes between a design rule for a first version of a design process kit for an integrated circuit technology node and a second version of a design process kit for the integrated circuit technology node.

Example 21 includes a system comprising a database comprising memory to store design rules for a plurality of integrated circuit technology nodes, the design rules having fields including a label, a description, a numerical dimension, and an operator associated with the numerical dimension; and a processor to generate design rule entries responsive to a request for design rules of a particular integrated circuit technology node, the design rule entries corresponding to the requested design rules, wherein the design rule entries are formatted for display of the fields of the design rules in a tabular format.

Example 22 includes the subject matter of Example 21, and wherein a design rule entry of the design rule entries comprises a selector that when activated through user interaction with an interface initiates display of at least one figure illustrating application of corresponding design rule.

Example 23 includes the subject matter of any of Examples 21 and 22, and wherein the display of the at least one figure illustrating application of the design rule includes a highlight of a label of the corresponding design rule.

Example 24 includes the subject matter of any of Examples 21-23, and wherein a design rule entry of the design rule entries comprises a link that when selected through user interaction with an interface initiates display of a label, description, and numerical dimension of a corresponding design rule, a figure associated with the corresponding design rule, and a link to a page for a second design rule that is related to the corresponding design rule.

Example 25 includes the subject matter of any of Examples 21-24, and wherein a description of the second design rule cites the label of the corresponding design rule or the description of the corresponding design rule cites a label of the second design rule.

Example 26 includes the subject matter of any of Examples 21-25, and wherein the numerical dimension and operator fields of a design rule comprise null values if the design rule does not specify a numerical dimension.

Example 27 includes the subject matter of any of Examples 21-26, and wherein the request specifies an integrated circuitry technology node and a process design kit version.

Example 28 includes the subject matter of any of Examples 21-27, the processor to provide a group of cells in a tabular format, wherein a cell of the group of cells illustrates changes between a design rule for a first integrated circuit technology node and a corresponding design rule for a second integrated circuit technology node.

Example 29 includes the subject matter of any of Examples 21-28, the processor to provide a group of cells in a tabular format, wherein a cell of the group of cells illustrates changes between a design rule for a first version of a design process kit for an integrated circuit technology node and a second version of a design process kit for the integrated circuit technology node.

Example 30 includes the subject matter of any of Examples 21-29, further comprising one or more of a battery communicatively coupled to the processor, a display communicatively coupled to the processor, or a network interface communicatively coupled to the processor.

Example 31 includes a system comprising means to perform any of the functionalities described in the previous examples.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. At least one machine readable storage medium having instructions stored thereon, the instructions when executed by a machine to cause the machine to:
access at least one filter parameter specifying a plurality of design rules for at least one integrated circuit technology node; and
provide a plurality of design rule entries for display in a tabular format by an interface, the plurality of design rule entries selected based on the at least one filter parameter, a design rule entry of the plurality of design rule entries corresponding to a design rule of the plurality of design rules, the design rule entry comprising a first cell designated for a label of the design rule, a second cell designated for a description of the design rule, and a third cell designated for a numerical dimension for the design rule.

2. The at least one medium of claim 1, the design rule entry comprising a fourth cell designated for at least one operator associated with the numerical dimension.

3. The at least one medium of claim 2, wherein the third cell and fourth cell comprise null values if the design rule does not specify a numerical dimension.

4. The at least one medium of claim 1, wherein the at least one filter parameter comprises an integrated circuitry technology node and a process design kit version.

5. The at least one medium of claim 1, wherein the design rule entry comprises a selector that when activated through user interaction with the interface initiates display of at least one figure illustrating application of the design rule.

6. The at least one medium of claim 5, wherein the display of the at least one figure illustrating application of the design rule includes a highlight of the label of the design rule.

7. The at least one medium of claim 1, wherein the design rule entry comprises a link that when selected through user interaction with the interface initiates display of the first cell, second cell, and third cell, a figure associated with the design rule, and a link to a page for a second design rule that is related to the design rule.

8. The at least one medium of claim 7, wherein a description of the second design rule cites the label of the design rule or the description of the design rule cites a label of the second design rule.

9. The at least one medium of claim 1, wherein the instructions when executed by the machine are to cause the machine to provide a group of cells in a tabular format, wherein a cell of the group of cells illustrates changes between a design rule for a first integrated circuit technology node and a corresponding design rule for a second integrated circuit technology node.

10. The at least one medium of claim 1, wherein the instructions when executed by the machine are to cause the machine to provide a group of cells in a tabular format, wherein a cell of the group of cells illustrates changes between a design rule for a first version of a design process kit for an integrated circuit technology node and a second version of a design process kit for the integrated circuit technology node.

11. A method comprising:
receiving, at a computing system, a request for design rules of an integrated circuit technology node; and
providing, by the computing system, a plurality of design rule entries for display in a tabular format by an interface, the plurality of design rule entries selected based on the request, a design rule entry of the plurality of design rule entries corresponding to a design rule of the design rules, the design rule entry comprising a first cell designated for a label of the design rule, a second cell designated for a description of the design rule, and a third cell designated for a numerical dimension for the design rule.

12. The method of claim 11, wherein the design rule entry comprises a fourth cell designated for at least one operator associated with the numerical dimension.

13. The method of claim 11, wherein the design rule entry comprises a selector that when activated through user interaction with the interface initiates display of at least one figure illustrating application of the design rule.

14. The method of claim 13, wherein the display of the at least one figure illustrating application of the design rule includes a highlight of the label of the design rule.

15. The method of claim 11, wherein the design rule entry comprises a link that when selected through user interaction with the interface initiates display of the first cell, second cell, and third cell, a figure associated with the design rule, and a link to a page for a second design rule that is related to the design rule.

16. A system comprising:
a database comprising memory to store design rules for a plurality of integrated circuit technology nodes, the design rules having fields including a label, a description, a numerical dimension, and an operator associated with the numerical dimension; and
a processor to generate design rule entries responsive to a request for design rules of a particular integrated circuit technology node, the design rule entries corresponding to the requested design rules, wherein the design rule entries are formatted for display of the fields of the design rules in a tabular format.

17. The system of claim 16, wherein a design rule entry of the design rule entries comprises a selector that when activated through user interaction with an interface initiates display of at least one figure illustrating application of corresponding design rule.

18. The system of claim 17, wherein the display of the at least one figure illustrating application of the design rule includes a highlight of a label of the corresponding design rule.

19. The system of claim 16, wherein a design rule entry of the design rule entries comprises a link that when selected through user interaction with an interface initiates display of a label, description, and numerical dimension of a corresponding design rule, a figure associated with the corresponding design rule, and a link to a page for a second design rule that is related to the corresponding design rule.

20. The system of claim 16, further comprising one or more of a battery communicatively coupled to the processor, a display communicatively coupled to the processor, or a network interface communicatively coupled to the processor.
